(19) United States
(12) Patent Application Publication
(10) Pub. No.: US 2026/0268880 A1
(43) Pub. Date: Sep. 10, 2026

(54) USER INTERFACE APPARATUS, METHOD AND COMPUTER PROGRAM FOR COMPOSING AN AUDIO OUTPUT FILE

(71) Applicant: HYPH IRELAND LIMITED, County Dublin (IE)

(72) Inventors: Max RENARD, County Dublin (IE); Anders THORSELL, County Dublin (IE)

(21) Appl. No.: 19/136,598

(22) PCT Filed: Nov. 20, 2023
(86) PCT No.: PCT/EP2023/082355

§ 371 Date: Jun. 6, 2025

Related U.S. Application Data
(63) Continuation of application No. 18/077,024, filed on Dec. 7, 2022.

(51) Int. Cl. G10H 1/00; G06F 3/0488

(52) U.S. Cl. CPC G10H 1/0008; G06F 3/0488

(57) ABSTRACT

Embodiments of the present invention relate to a user interface apparatus, method and computer program for composing an audio output file, the user interface apparatus including: an arrangement of interactively operable visual elements displayed on display means, each visual element represents an instrument content block, and each instrument content block comprises musical content sub-blocks from a musical instrument and has a plurality of audio parameters, wherein an instrument content block is activated by a user tapping the corresponding visual element with pointing means, and whereby, when an instrument content block is activated by a user one or more of a plurality of interactive authoring tools are provided to enable the user to adjust audio parameters of the activated instrument content block, and the audio parameters adjusted by the user are applied to the instrument content block, and means for combining the instrument content blocks to generate the audio output file.

### CROSS REFERENCE

This application is a U.S. National Stage Patent Application filed under 35 U.S.C. § 371 of International Patent Application No. PCT/EP2023/082355 filed 20 Nov. 2023 which claims priority to Ser. No. 18/077,024 filed 7 Dec. 2022, the entire contents of all of which are hereby incorporated by reference as if fully set forth herein for all purposes.

### TECHNICAL FIELD

The present disclosure relates to a user interface apparatus, method and computer program for composing an audio output file. The disclosure further relates to a user interface apparatus, method, and computer program for creating multimedia files comprising an audio output file composed by the user interface apparatus.

### BACKGROUND

Digital audio workstations (DAWs) have been developed to provide users with a production environment in which audio content may be composed, recorded, edited, mixed and optionally synchronized with target image or video content.

Such DAWs are typically configured with an arrangement of tools and a library of pre-recorded audio content which users may select, edit and combine to create an audio output file and, if desired, to synchronize the audio output file created with multimedia content, such as images and/or video files.

However, such production environments are often very difficult to use and selection by users of harmonically compatible pre-recorded audio content files for an audio output file is extremely time consuming, even for the most skilled audio editors. Moreover, the extent to which such environments enable users to efficiently and easily edit or change audio output files created is limited due to their complexity and often unfriendly user interfaces.

It is therefore an object of the present disclosure to provide a user interface apparatus, method and computer program for composing an audio output file that goes at least some way toward overcoming the above problems and/or provides the public or industry with a useful alternative.

Further aspects of the present invention will become apparent from the ensuing description which is given by way of example only.

### SUMMARY

According to embodiments of the invention, there is provided a user interface apparatus for composing an audio output file, the user interface apparatus including:
a. an arrangement of interactively operable visual elements displayed on display means, each visual element represents an instrument content block, and each instrument content block comprises musical content sub-blocks from a musical instrument and has a plurality of audio parameters,
b. wherein an instrument content block is activated by a user tapping the corresponding visual element with pointing means, and
c. whereby, when an instrument content block is activated by a user one or more of a plurality of interactive authoring tools are provided to enable the user to adjust audio parameters of the activated instrument content block, and the audio parameters adjusted by the user are applied to the instrument content block,
d. means for composing the audio output file by combining the instrument content blocks.

Embodiments provide a user interface apparatus for managing the technical task of creating, editing and composing an audio output file that may be played so that it may be listened to on audio output means of a device, such as a speaker or headphone. The user interface apparatus displays interactively operable visual elements each representing instrument content blocks (that is, individual instrumental components) of an audio output file generated. By tapping a visual element with pointing means a user may activate an instrument content block, and when activated the user is provided with interactive authoring tools which are configured to enable the user to adapt various audio parameters of the instrument content blocks and the musical content sub-blocks making up the instrument content blocks. By the user interface users may edit and adjust the way an instrument content block sounds to thereby alter the way the audio output file sounds when generated and played.

Embodiments of the present invention by its provision of visual elements representing individual instrument components and interactive authoring tools compatible with the visual elements enables music to be visualised by users thereby providing an intuitive and simpler interface for creation, composition and editing of an audio output file.

Embodiments of the present invention by the user interface initially provides users with a choice to request the generation of an audio output file comprising a random selection of harmonically compatible instrument content blocks. Alternatively, the initial selection of harmonically compatible instrument content blocks may be based on a style selection (such as pop, synth, reggae, etc.) made by a user via user interface means. Therefore, when users start a composition or creation process in the application they are given the choice of receiving an audio output file based on a fully random selection of harmonically compatible instrument content blocks or to first select a style upon which the selection of harmonically compatible instrument content blocks is to be based.

Once an initial selection of harmonically compatible instrument content blocks is provided users may then apply the editing and authoring tools of embodiments of the present invention to change, alter, adjust, shuffle and/or remove the instrument content blocks in the selection and the sound audio output file und according to their preferences.

The user interface apparatus is communicatively coupled to means configured for composing the instrument content blocks from a library of pre-recorded musical content sub-blocks, in which each musical content sub-block is from a musical instrument and the instrument content blocks selected for an audio output file are harmonically compatible.

The user interface apparatus may be displayed by a digital display of a user electronic device, such as mobile smart phone or tablet. A software application may be downloaded and installed on the electronic device for the display of the user interface. However, in some embodiments, the electronic device may execute a web browser application which browses to a website served by a web server, wherein the user interface embedded therein is displayed.

In an embodiment, the interactive authoring tools include means for instrument content block shuffle means configured so that when a visual element for an instrument content block is swiped with pointing means by a user the instrument content block is replaced with an alternative instrument content block.

In an embodiment, the instrument content block shuffle means further comprises means for replacing the instrument content blocks with an alternative selection of instrument content blocks.

In an embodiment, the interactive authoring tools include means for muting, locking, deleting, changing a musical style of, restoring a previously replaced, and/or playing an instrument content block.

In an embodiment, the interactive authoring tools provided to a user are dependent on the length of time a user taps a visual element, whereby a relatively short tap provides a first subset of the interactive authoring tools, and a relatively long tap provides a second subset of the interactive authoring tools.

In an embodiment, the interactive authoring tools include means for enabling users to search a database according to an existing artist name and/or song name to provide an audio output file with a desired sound and timbre similar to the existing artist and/or song name.

In an embodiment, the interactive authoring tools include means for enabling users to individually alter the volume of each instrument content block.

In an embodiment, the interactive authoring tools include means for displaying the audio output file divided into a plurality of sections, in which each section displayed is populated by musical content sub-blocks for each instrument content block, and whereby the user interface comprises means enabling users to disable and enable one or more musical content sub-blocks for an instrument content block in a section of the audio output file.

In an embodiment, the interactive authoring tools include means for enabling users to reorder the sections of the audio output file.

In an embodiment, the interactive authoring tools include means for displaying selectable alternative section layout templates, whereby users may select a desired section layout from a plurality of optional section layouts. Such section layouts may be displayed as a scrollable list, icons, or the like. A user may be provided with three, four or more section layout template options.

In an embodiment, a section layout template comprises between five to eight sections.

In an embodiment, the interactive authoring tools include means for enabling users to add an instrument content block for a selected instrument and genre to the instrument content blocks in the audio output file.

In an embodiment, the interactive authoring tools include means for enabling users to change the pitch and tempo of the audio output file.

In an embodiment, the interactive authoring tools include means for enabling users to configure the audio output file for use in a short message capable of transmitted using a messaging service via a network to a device.

Such a short message comprising the audio output file may have a duration or length of up to about thirty seconds, although optimally may have a duration of between three to twenty seconds, three to fifteen seconds, or three to nine seconds.

The short message comprising the audio output file may further contain or be synchronized with one or more multimedia files, such as one or more image and/or video files, such that the audio output file is combined with the one or more multimedia files when the short message is played on the device.

In an embodiment, the arrangement of interactively operable visual elements further comprises a visual element representing an empty vocal content block, wherein the empty vocal content block is activated by a user tapping the corresponding visual element with pointing means, and when activated the user interface provides means for enabling a user to record, using input means such as a microphone, a vocal melody or other audio input recording and store the recorded vocal melody or other audio input for use in a vocal content block.

In an embodiment, the interactive authoring tools include means for enabling users to individually alter the volume of each instrument content block and/or the volume of each vocal content block.

In an embodiment, the interactive authoring tools include means for recording, using input means such as a microphone, a vocal melody or other audio input as a vocal recording for selected predefined sections of the audio output file.

In an embodiment, the interactive authoring tools include means for displaying lyrics for a recorded vocal content block.

In an embodiment, the arrangement of interactively operable visual elements further comprises a plurality of visual elements each representing an empty vocal content block.

In an embodiment, the arrangement of interactively operable visual elements further comprises a visual element representing at least one vocal content block, wherein each vocal content block is activated by a user tapping the corresponding visual element with pointing means, and when activated a plurality of interactive authoring tools are provided for enabling the user to adjust audio parameters of the activated vocal content block.

In an embodiment, the interactive authoring tools include means to autotune the vocal melody or other audio input of a vocal content block. Such autotune functionality may be provided by a value slider to adjust a level of autotune.

In an embodiment, the interactive authoring tools include means for means for displaying a recorded vocal content block as a waveform of line that moves to the vocal as it is recorded on display means.

In an embodiment, the interactive authoring tools include means for trimming the recorded vocal melody or other audio input of a recorded vocal content block.

In an embodiment, the user interface comprises means for displaying vocal recordings for a user as visual elements, wherein the vocal recordings are activated by a user tapping the corresponding visual element with pointing means, whereby when activated a plurality of interactive authoring tools are provided for enabling the user to adjust audio parameters of the vocal recordings.

In an embodiment, the interactive authoring tools further provides means for muting, locking, deleting, changing a musical style of, applying filters to, adjusting volume of, adjusting autotune level of, trimming, duplicating, naming and renaming, playing and/or restoring vocal recordings.

In an embodiment, the display means is a touch screen, and the pointing means is provided by a finger of a user or a stylus. Alternatively, the pointing means is a mouse, and an instrument content block is activated or removed by a user positioning and pressing or dragging a mouse pointer over the corresponding visual element.

In an embodiment, each visual element includes a visual indication of a musical instrument corresponding to the musical content in the instrument content block.

In an embodiment, the visual indication is the name of the instrument written within or adjacent to the visual element.

In an embodiment, the visual indication is an image depicting the instrument shown within or adjacent to the visual element.

In an embodiment, each visual element is an image of a shape.

In an embodiment, each visual element is an image of a ring.

According to embodiments of the invention, there is provided method of composing an audio output file using a user interface apparatus, the method including:
a. providing an arrangement of interactively operable visual elements displayed on display means, each visual element represents an instrument content block, and each instrument content block comprises musical content sub-blocks from a musical instrument and has a plurality of audio parameters,
b. wherein an instrument content block is activated by a user tapping the corresponding visual element with pointing means, and
c. whereby, when an instrument content block is activated by a user one or more of a plurality of interactive authoring tools are provided to enable the user to adjust audio parameters of the activated instrument content block, and the audio parameters adjusted by the user are applied to the instrument content block,
d. combining the instrument content blocks to compose the audio output file.

In an embodiment, the method includes a step of providing an interactive authoring tool including instrument content block shuffle means configured so that when a visual element for an instrument content block is swiped with pointing means by a user the instrument content block is replaced with an alternative instrument content block.

In an embodiment, the instrument content block shuffle means further comprises means for replacing the instrument content blocks with an alternative selection of instrument content blocks.

In an embodiment, the method includes a step of providing an interactive authoring tool including means for muting, locking, deleting, changing a musical style of, restoring a previously replaced, and/or playing an instrument content block.

In an embodiment, the method includes a step of providing an interactive authoring tool including means for enabling users to search a database according to an existing artist name and/or song name to provide an audio output file with a desired sound and timbre similar to the existing artist and/or song name.

In an embodiment, the method includes a step of providing an interactive authoring tool including means for enabling users to individually alter the volume of each instrument content block.

In an embodiment, the method includes a step of providing an interactive authoring tool including means for displaying the audio output file divided into a plurality of sections, in which each section displayed is populated by musical content sub-blocks for each instrument content block, and whereby the user interface comprises means enabling users to disable and enable one or more musical content sub-blocks for an instrument content block in a section of the audio output file.

In an embodiment, the method includes a step of providing an interactive authoring tool including means for reordering the sections of the audio output file.

In an embodiment, the method includes a step of providing an interactive authoring tool including means for displaying selectable alternative section layout templates, whereby users may select a desired section layout from a plurality of optional section layouts. Such section layouts may be displayed as a scrollable list, icons, or the like. A user may be provided with three, four or more section layout template options.

In an embodiment, a section layout template comprises between five to eight sections.

In an embodiment, the method includes a step of providing an interactive authoring tool including means for adding an instrument content block for a selected instrument and genre to the instrument content blocks in the audio output file.

In an embodiment, the method includes a step of providing an interactive authoring tool including means for changing the pitch and tempo of the audio output file.

In an embodiment, the method includes a step of providing an interactive authoring tool including means for enabling users to configure the audio output file for use in a short message capable of transmitted using a messaging service via a network to a device.

In an embodiment, the method includes a step of providing an arrangement of interactively operable visual elements which further comprises a visual element representing an empty vocal content block, wherein the empty vocal content block is activated by a user tapping the corresponding visual element with pointing means, and when activated the user interface provides means for enabling a user to record, using input means such as a microphone, a vocal melody or other audio input recording and store the recorded vocal melody or other audio input for use in a vocal content block.

In an embodiment, the method includes a step of providing an interactive authoring tool including means for recording, using input means such as a microphone, a vocal melody or other audio input as a vocal recording for selected predefined sections of the audio output file.

In an embodiment, the method includes a step of providing an interactive authoring tool including means for displaying lyrics for a recorded vocal content block.

In an embodiment, the arrangement of interactively operable visual elements further comprises a plurality of visual elements each representing an empty vocal content block.

In an embodiment, the method includes a step of providing an arrangement of interactively operable visual elements further comprising a visual element representing at least one vocal content block, wherein each vocal content block is activated by a user tapping the corresponding visual element with pointing means, and when activated a plurality of interactive authoring tools are provided for enabling the user to adjust audio parameters of the activated vocal content block.

In an embodiment, the method includes a step of providing an interactive authoring tool with means for enabling users to individually alter the volume of each instrument content block and/or the volume of each vocal content block.

In an embodiment, the method includes a step of providing an interactive authoring tool including means for autotuning the vocal melody or other audio input of a vocal content block. Such autotune functionality may be provided by a value slider to adjust a level of autotune.

In an embodiment, the method includes a step of providing an interactive authoring tool including means for displaying a recorded vocal content block as a waveform on display means. Such autotune functionality may be provided by a value slider to adjust a level of autotune.

In an embodiment, the method includes a step of providing an interactive authoring tool including means for trimming the recorded vocal melody or other audio input of a recorded vocal content block.

In an embodiment, the method includes a step of providing an interactive authoring tool including means for displaying vocal recordings for a user as visual elements, wherein the vocal recordings are activated by a user tapping the corresponding visual element with pointing means, whereby when activated a plurality of interactive authoring tools are provided for enabling the user to adjust audio parameters of the vocal recordings.

In an embodiment, the method includes a step of providing an interactive authoring tool including means for muting, locking, deleting, changing a musical style of, applying filters to, adjusting volume of, adjusting autotune level of, trimming, duplicating, naming and renaming, playing and/or restoring vocal recordings.

According to embodiments of the invention, there is provided a computer program that, when run on a computer, performs the steps according to the method as described.

### BRIEF DESCRIPTION OF THE DRAWINGS

Embodiments of the invention will be more clearly understood from the following description of some embodiments thereof, given by way of example only, with reference to the accompanying drawings in which:

FIG. 1 is an exemplary user interface screen of the user interface apparatus according to embodiments of the invention showing instrument content blocks and a vocal content block for an audio output file,

FIGS. 2 to 10 are exemplary user interface screens of the user interface apparatus according to embodiments of the invention showing the interactive authoring tools by which users edit and adjust one or more instrument content blocks for an audio output file, and

FIGS. 11 to 22 are exemplary user interface screens of the user interface apparatus according to embodiments of the invention showing the interactive authoring tools by which users create, edit and adjust one or more vocal content blocks for an audio output file.

### DETAILED DESCRIPTION

Embodiments of the present invention are implemented by one or more computer processors and memory including computer software program instructions executable by the one or more processors. The computer processors may be provided by a computer server or network of connected and/or distributed computers.

The audio files of embodiments of the present invention will be understood to be received, stored or recorded files containing audio or MIDI data or content which produce sound output when processed by an audio or MIDI player. An audio output file may be recorded in known audio file formats, including, but not limited to, audio WAV format, MP3 format, advanced audio coding (AAC) format, Ogg format or in any other format, analog, digital or otherwise, as required. The desired audio or MIDI format may optionally be specified by a user.

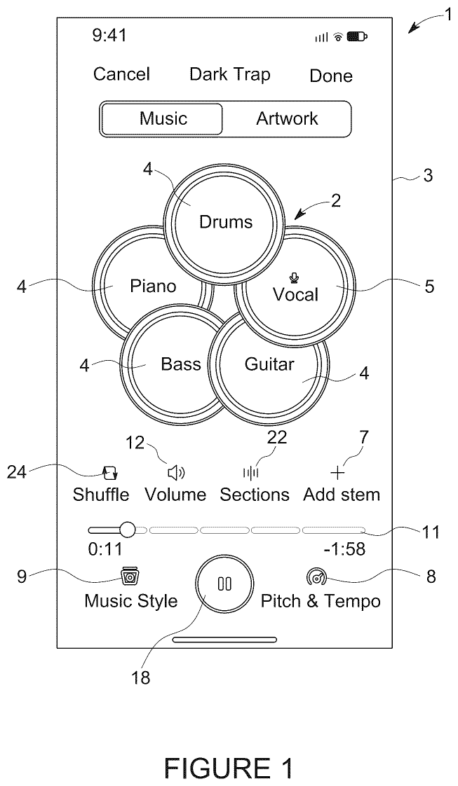

FIGS. 1 to 18 show a user interface apparatus, indicated generally by the reference numeral 1, for composing an audio output file.

The user interface apparatus 1 is communicatively coupled to a backend software application operable to select suitable instrument content blocks 4 for an audio output file from a library of pre-recorded instrument content sub-blocks or stems 6, in which the instrument content blocks 4 selected are harmonically compatible.

Each instrument content sub-block 6 comprises musical content from a specific musical instrument, such as a piano, a drum, a synthesiser, guitar, bass and the like, and are derived from musical performances created by human composers or musicians. Associated with instrument content blocks 4 and musical content sub-blocks 6 are a plurality of audio parameters, such as, pitch, tempo, volume, style, genre, etc. Accordingly, the instrument content sub-blocks 6 of embodiments of the present invention are derived from a specific musical instrument, and a plurality of such musical content sub-blocks provide an instrument content block 4 for an audio output file.

The selection of instrument content blocks 4 may be made automatically by the backend software application based on input parameters provided by a user, such as instrument type, style and/or genre.

When users start the composition process they may be provided with a choice to request the generation of an audio output file comprising a random selection of harmonically compatible instrument content blocks. Alternatively, the initial selection of harmonically compatible instrument content blocks may be based on a style selection (such as pop, synth, reggae etc) made by a user via user interface means.

As shown in FIG. 1, which is shown by way of example only, the backend software application has selected instrument content blocks 4 corresponding to four musical instruments including “Drums”, “Piano”, “Bass” and “Guitar”, although it will be understood that other instruments, such as a Synthesizer, Violin, Brass, Accordion etc may be selected by a user or according to audio parameters provided by a user, or a selected automatically by the backend software application, for an audio output file.

Also shown in FIG. 1 is a vocal content block 5 which is an audio recording of a vocal melody or other audio input provided by a user or by a stored pre-recording of an audio input. When a user provides as an input file a vocal recording or imports a stored pre-recording of an audio input embodiments of the present invention analyse musical parameters of the audio input file, such as the chord progression and tempo thereof, and selects harmonically compatible instrument content blocks that combine with the vocal content block to provide the audio output file.

It will be understood that an audio output file is generated by combining and playing the instrument content blocks 4 represented by the instrument content blocks 4 and if applicable, a vocal content block or vocal content blocks 5. Inclusion of one or more vocal content blocks 5 in an audio output file is optional. Any change to an individual instrument content block 4 and inclusion of a vocal content block(s) 5 will therefore have an impact on the final sound of the audio output file when played.

As shown in FIG. 1, the user interface apparatus 1 displays an arrangement of interactively operable visual elements 2 on display means 3 of a user electronic device, such as mobile smart phone, tablet, laptop, PC, or the like. The display means 3 may be a touch screen, a non-touch sensitive visual display monitor, a headset display or other visual display coupled to or integrated with a user electronic device. The display means 3 shown is a touch screen, and in such an embodiment the pointing means is provided by a finger of a user. Alternatively, in an embodiment in which the display means 3 is not a touch sensitive screen the pointing means may be provided by a mouse or other suitable pointing device.

Each visual element 2 represents an instrument content block 4 or a vocal content block 5 and, in the instance shown, is provided in the shape of a ring 2. It will however be appreciated that each visual element 2 may be provided in an alternative shape, such a square, a diamond, an oval, or other desired shape, or with an image depicting the instrument from which the instrument content block 4 is derived. Reference to the visual elements 2 of embodiments of the present invention being shown as rings 2 should therefore not be seen as limiting.

Each instrument content block 4 is activated by a user tapping the corresponding ring 2 with pointing means. When an instrument content block 4 is activated one or more of a plurality of interactive authoring tools are provided which to give the user various means to adjust audio parameters of the activated instrument content block 4. The vocal content block 5 is also activated by a user tapping the corresponding visual element 2 with pointing means, and when activated a plurality of interactive authoring tools are provided for enabling the user to adjust audio parameters of the vocal melody or other audio input for the activated vocal content block 5. Although one such vocal content block 5 is shown it will be understood that an audio output file may comprise a plurality of such vocal content blocks 5.

The user interface apparatus 1 comprises an interactive authoring tool provided as an instrument content block shuffle means configured so that when a visual element 2 for an instrument content block 4 is swiped with pointing means by a user the swiped instrument content block 4 is replaced with an alternative instrument content block 4 of the same instrument and that is harmonically compatible with the remaining instrument content blocks 4.

The instrument content block 4 shuffle means further comprises means 24 for replacing all of the instrument content blocks 4 with an alternative selection of instrument content blocks 4.

The user interface apparatus 1 further comprises an interactive authoring tool providing means 7 for enabling users to add a further instrument content block 4 for a selected instrument and genre to the instrument content blocks 4 in the audio output file. An interactive authoring tool also provides means 8 for enabling users to change the pitch and tempo of the audio output file and means 9 for enabling users to change the musical style of the audio output file.

Also shown is a timeline 11 showing the progression of the audio output file as it is played via the user interface apparatus 1 together means 18 to pause an audio output file as it is played. The playback volume may be adjusted by volume control 12.

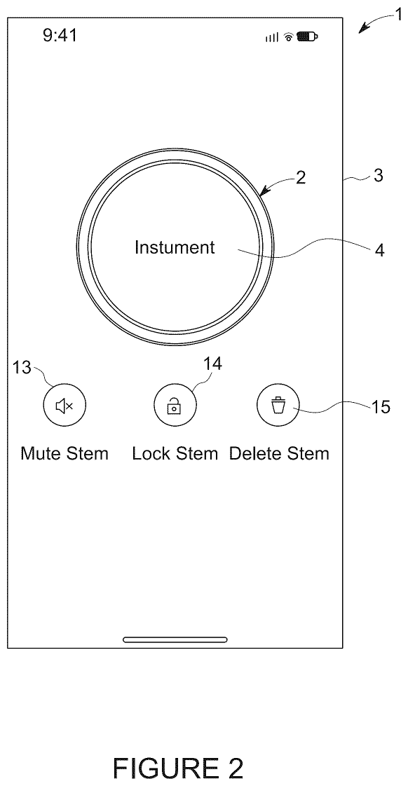

FIG. 2 shows a plurality of interactive authoring tools that are provided when a user has long tapped a ring 2 for an instrument content block 4, which in the instance shown includes functionality to provide means to mute 13, lock 14 (that is, prevent alteration/editing and removal from a selection) and delete 15 an individual instrument content block 4. It will be understood that long tapping ring 2 involves a user tapping the ring 2 and holding for a few seconds to access the interactive authoring tools provided.

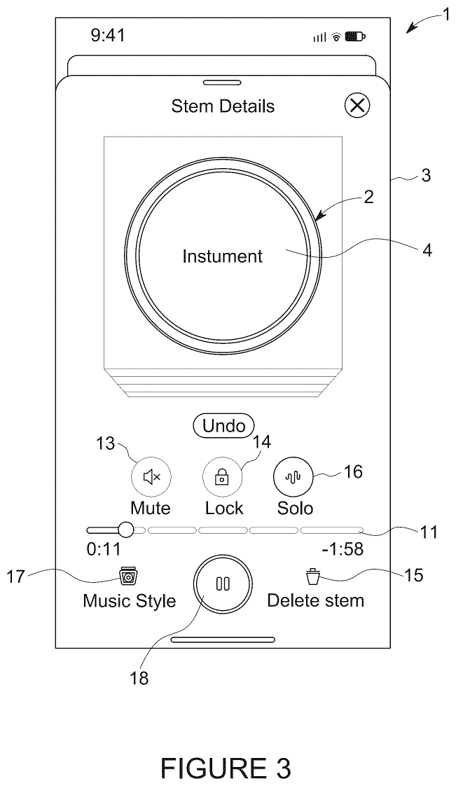

FIG. 3 shows a plurality of further interactive authoring tools that are provided when a user has quick tapped a ring 2, which includes the above means to mute 13, lock 14 and delete 15 the activated instrument content block 4, and means to play/solo 16, alter the style 17 and pause a playing 18 individual instrument content block 4. Also shown is a timeline 11 showing the progression of the activated instrument content block 4 while it is played.

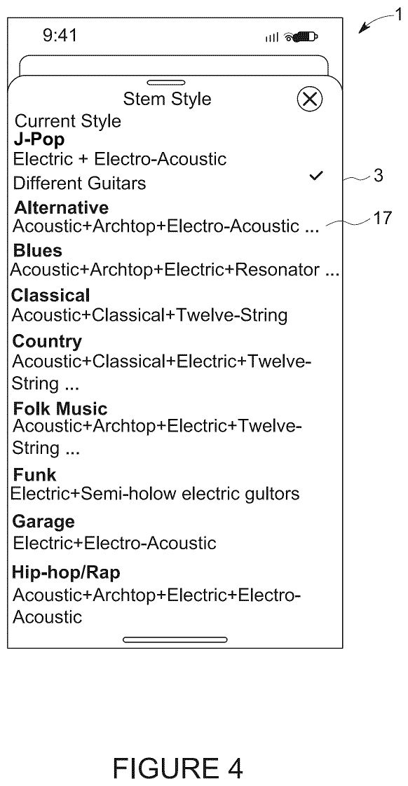

FIG. 4 shows the interactive authoring tool providing means 17 by which a user may select the musical style for an activated instrument content block 4. Thus, in the instance shown, the activated instrument content block 4 is for a Guitar with the current style J-Pop, and should a user elect to change the Guitar style they may select by from the alternative styles provided by using pointing means.

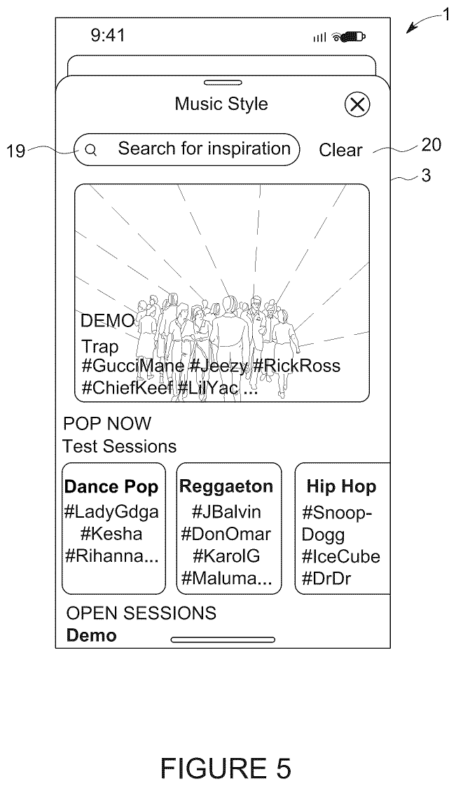

FIG. 5 shows an interactive authoring tool providing means 20 enabling users to search a database according to an existing artist name and/or song name to provide a selection of instrument content blocks 4 with a desired sound and timbre similar to the existing artist and/or song name. Shown is a database query function 19 for users to input an existing artist name and/or song name to locate instrument content blocks 4 matching the query for the audio output file.

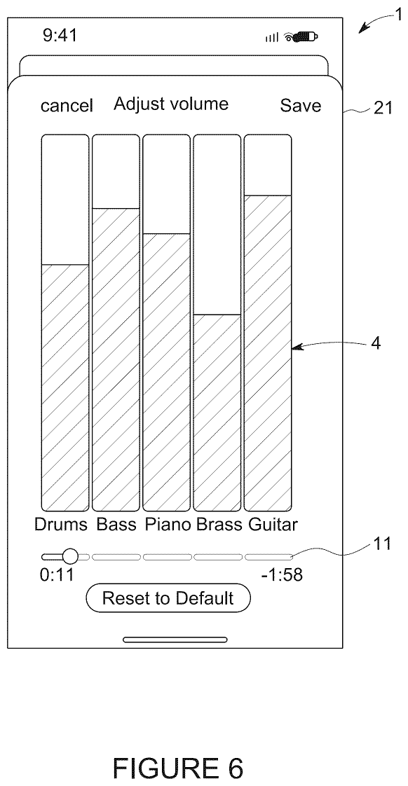

FIG. 6 shows an interactive authoring tool providing means 21 for enabling users to individually alter the volume of each instrument content block 4 in the audio output file, together with a playback timeline 11. In embodiments in which a vocal content block is included the volume may be adjusted for the vocal in the same way.

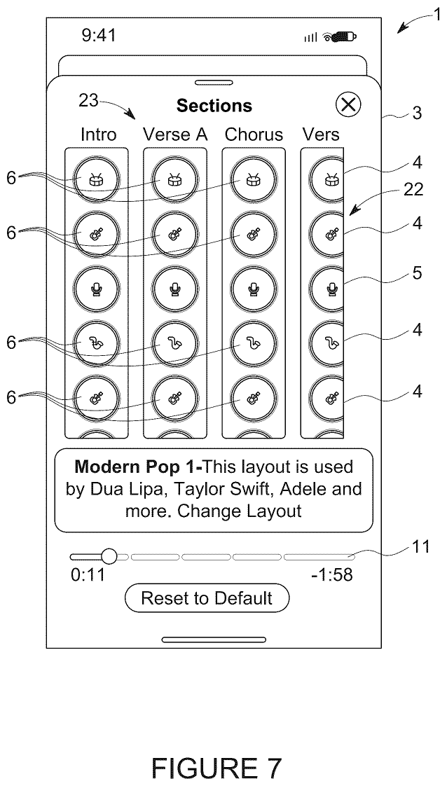

FIG. 7 shows an interactive authoring tool providing means 22 for displaying the instrument content blocks 4 and vocal content blocks 5 for the vocal part of an audio output file in a plurality of sections 23. The sections 23 are shown by way of example, as “Intro”, Verse A”, Chorus”. Each section 23 is populated by the instrument content sub-blocks 6 making up the instrument content block 4, and the vocal content block 5 is also divided into parts for each section. Means 22 enables users to disable and enable individual musical content sub-blocks 6, individual instrument content blocks 4 and/or vocal content blocks 5 in a section 23. Means 22 further enables users to reorder the sections 23, and to reorder musical content sub-blocks 6 and the vocal content block parts 5 in a section 23.

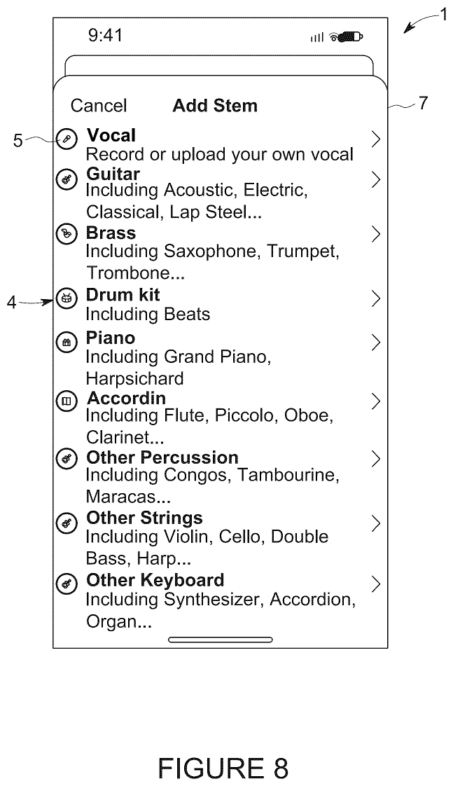

FIG. 8 shows the interactive authoring tool providing means 7 enabling a user may add an instrument content block 4 (“Add stem”) or a vocal content block 5, to the audio output file. Means 7 is activated when a user selects by tapping the “Add stem” icon shown in FIG. 1 and when selected a user may select from an instrument type, including, for example, guitar, brass, drum kit and the like for the instrument content block 4.

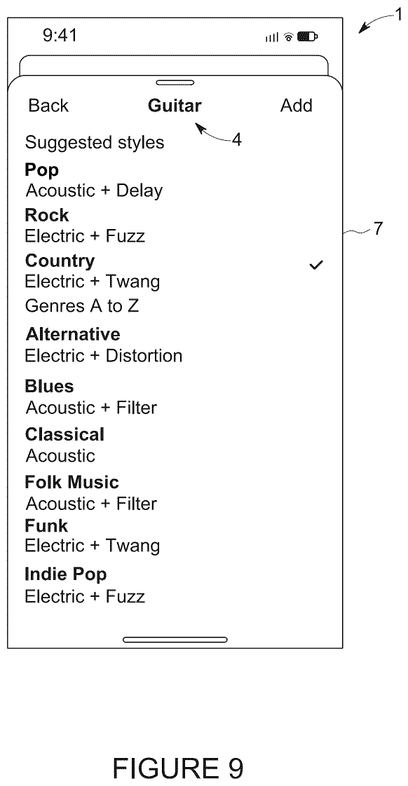

As shown in FIG. 9, when adding an instrument content block 4 users may also specify a genre and/or style for a selected instrument type, which in the instance shown are genre and/or styles for a “Guitar”. Suggested genres are also provided by the backend software application based on the existing instrument content blocks 4 in the audio output file.

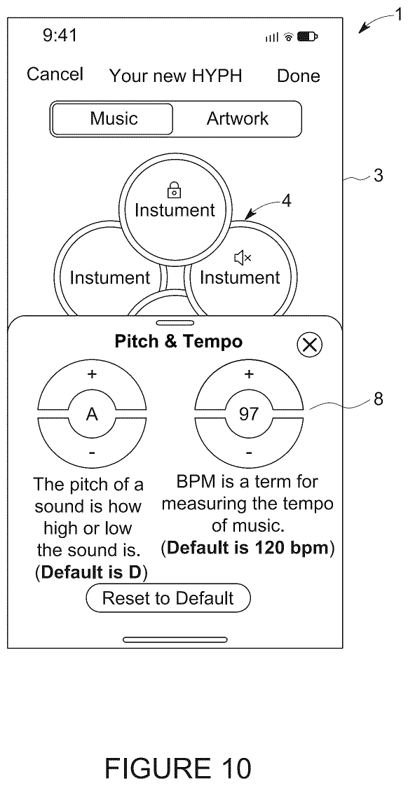

FIG. 10 shows the interactive authoring tool providing means 8 for enabling users to change the pitch and tempo of the audio output file.

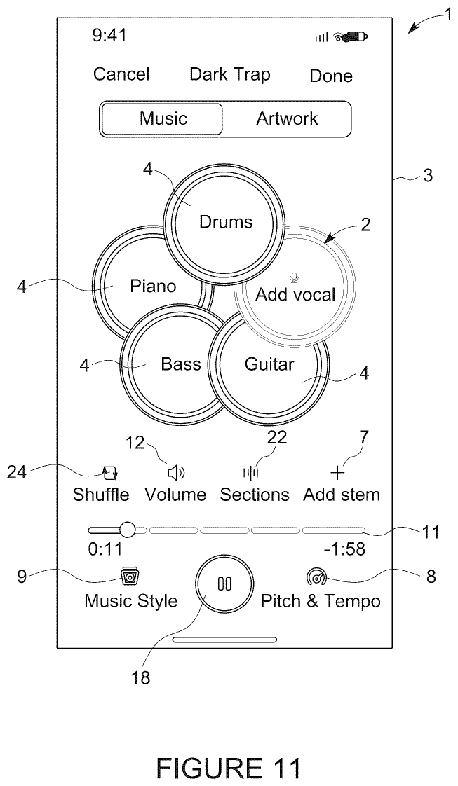

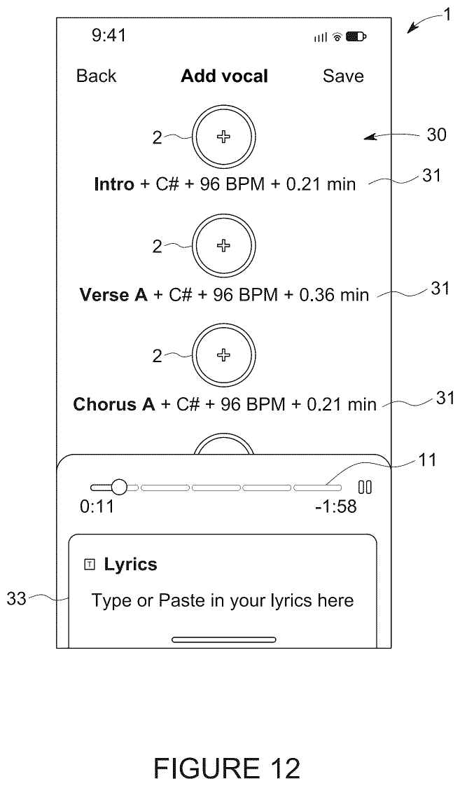

FIG. 11 shows a screen similar to FIG. 1, in which a vocal content block 5 is not currently included in an audio output file, and accordingly, user interface apparatus 1 includes “Add vocal” ring 2, which when tapped by a user operating pointing means activates the interactive authoring tool providing means 30 of FIG. 12, which enables a user to record a vocal melody or other audio input and store the recorded vocal melody or other audio input as a recorded vocal content block 5 for the audio output file.

According to FIG. 12 the vocal recording means 30 enables a user to record a vocal melody in pre-defined section parts 31, such as “Intro”, “Verse A”, Chorus A” etc by activating the corresponding ring 2 with the “+” symbol therein. Also shown is a timeline 11 showing the playback progression of recorded vocal content as it is played. Also provided is means 33 for displaying lyrics for a recorded vocal content block 5. Lyrics may optionally be automatically generated by a lyrics generator.

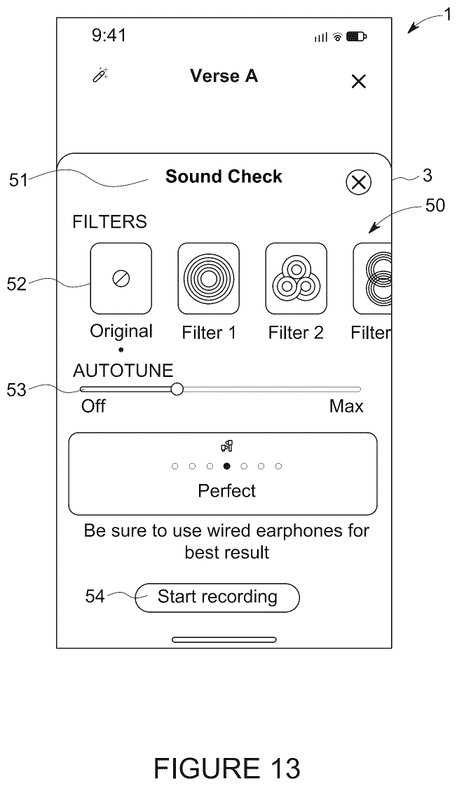

FIG. 13 shows an interactive authoring tool providing means 50 enabling a user to set up recording parameters and start recording content for pre-defined section parts 31 of a vocal recording, which in the instance shown is “Verse A” of a vocal content block 5. Shown is a sound check 51 for audio input means, such as a microphone, filters 52 and autotune levels 53 for the vocal recording and a start recording icon 54.

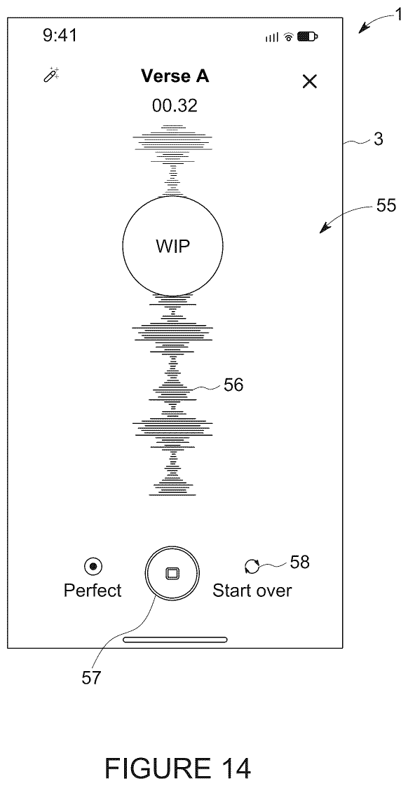

FIG. 14 shows an interactive authoring tool providing means 55 for displaying vocal content being recorded as a waveform 56 for the pre-defined section parts 31. The interactive authoring tool providing means 57 to stop and means 58 to restart the recording.

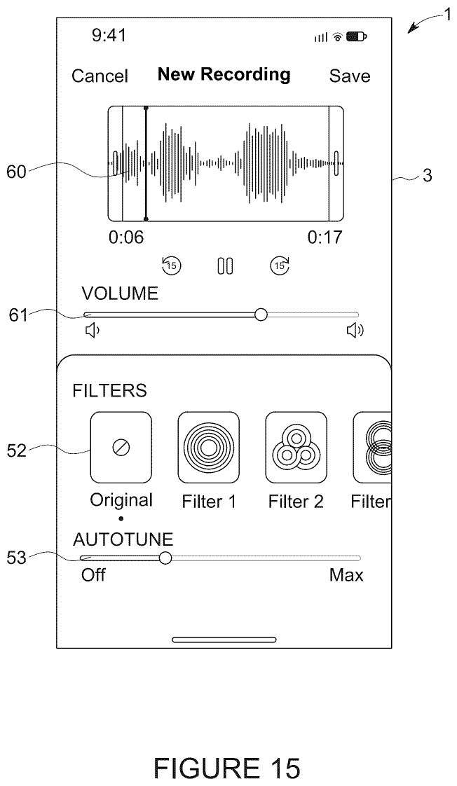

FIG. 15 shows interactive authoring tools provided once a user has completed a vocal recording for a section part 31 of a vocal content block 5. Shown are means 53 enabling users to autotune the vocal melody or other audio input of a vocal recording. Such autotune functionality may be provided by a value slider to adjust the level of autotune. Also provided is means 52 for setting filters to a vocal recording, means 60 for displaying a vocal recording as a waveform or “moving” line on display means 3, together with the means 61 for volume adjustment of the vocal recording on a timeline. The vocal recording may be trimmed by appropriately cutting/marking the wave or “moving” line.

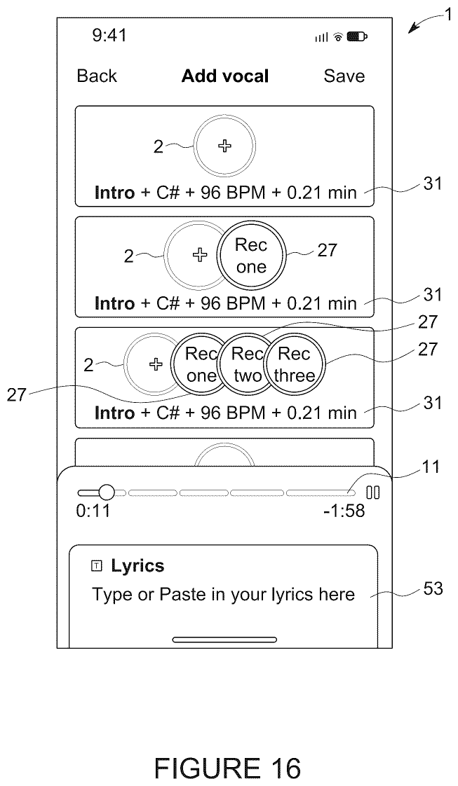

FIG. 16 shows an interactive authoring tool providing means 70 enabling users to store and display vocal recordings 27 made for each pre-defined section 31. New vocal recordings 27 for use in a vocal content block 5 may be recorded for a pre-defined section 31 by tapping with pointing means the vocal ring 2 with the “+” symbol displayed therein. Each vocal recording 27 may be stored with an identifying name, which in the instance shown are “Rec one”, “Rec two” and so on. Means 70 also provides a playback timeline 11 and means 33 for displaying lyrics for a recorded vocal content block 5.

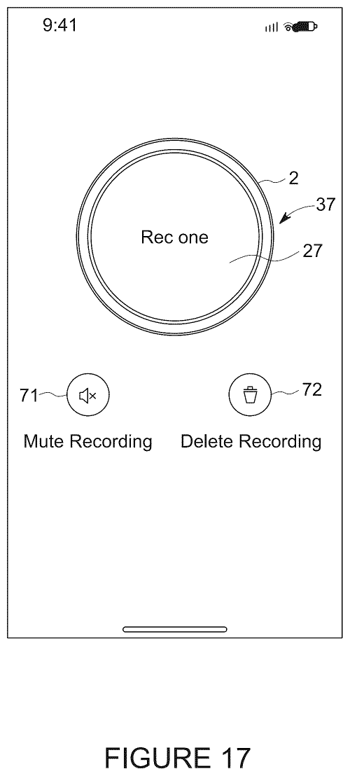

FIG. 17 shows an interactive authoring tool providing means 37 comprising means 71 to mute a vocal recording 27, shown as vocal recording “Rec One”, and means 72 enabling users to delete the vocal recording 27.

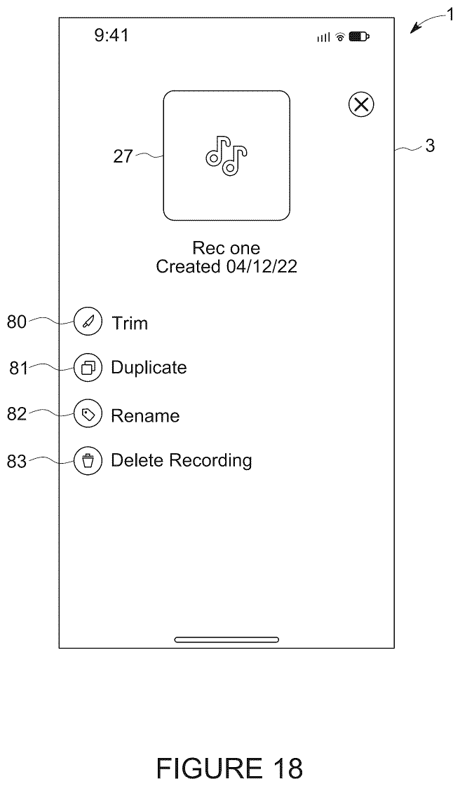

FIG. 18 shows an interactive authoring tool providing means 80 for trimming a vocal recording 27, means 81 to duplicate a vocal recording 27, means 82 to rename a vocal recording 27, and means 83 to delete a vocal recording 27.

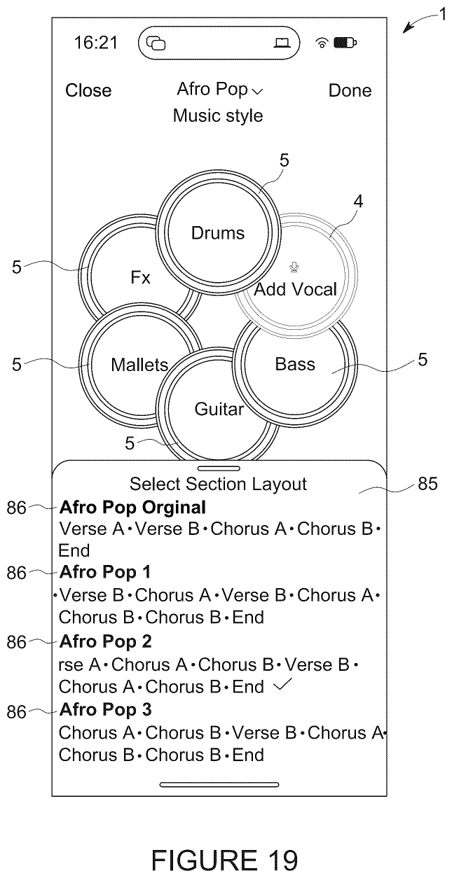

FIG. 19 shows an interactive authoring tool including means 85 for displaying selectable alternative section layout templates 86, whereby users may select a desired section layout from a plurality of optional section layout templates 86. Such section layouts may be displayed as a scrollable list, icons, or the like. A user may be provided with three, four or more section layout template options from which to choose one. In the instance shown, the “Afro Pop Original layout comprises five sections arranged in the order “Verse A”, “Verse B”, “Chorus” and “End”.

Each section is generally eight bars in length although some sections may have less than eight bars, such as the “End” section which as shown is two bars in length. A section layout template may comprise between five to eight sections according to various factors, including desired duration of the audio output file. Rearranging the sections for a template provides an alternative layout.

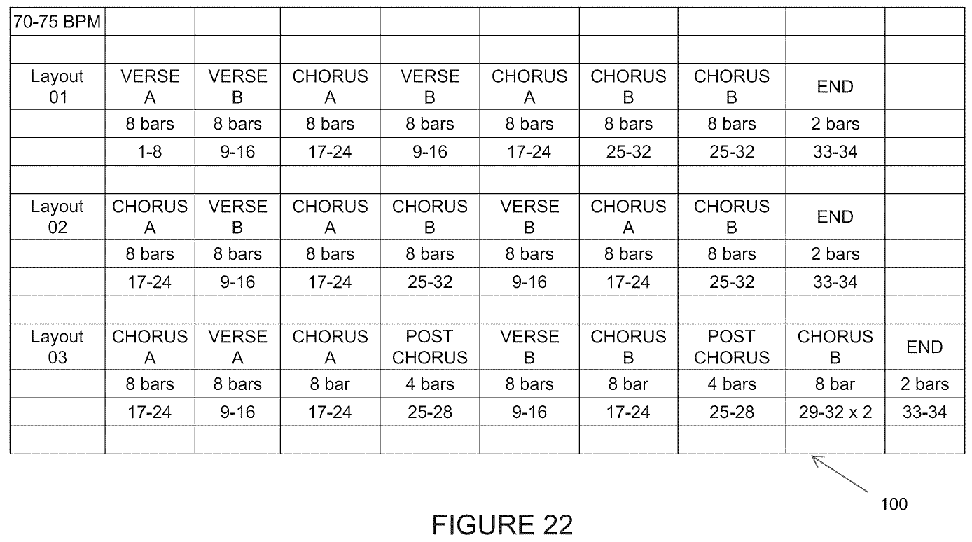

Shown in FIG. 22 is a table 100 showing three sample section layouts for a music style set at 70-75 bpm. Layout 1 comprises eight sections in the order:
a. Verse A, Verse B, Chorus A, Verse B, Chorus A, Chorus B, Chorus B, END Layout 2 also comprises eight sections in the order:
b. Chorus A, Verse B, Chorus A, Chorus B, Verse B, Chorus A, Chorus B, END Layout 3 comprises nine sections in the order:
c. Chorus A, Verse A, Chorus A, Post Chorus, Verse B, Chorus B, Post Chorus, Chorus B, END

As shown, each section of a layout comprises a plurality of bars (typically eight) of music and by rearranging the sections a new template layout is provided.

Such template layouts may be provided at different musical speeds, such as 80-85 bpm, 92-100 bpm, 107-116 bpm, 120 bpm and/or 130 pm.

Also provided is an interactive authoring tool having means enabling users to select portions of adjacent sections and combine these selected section portions to form a new section that may be dynamically included in a new or an existing layout template. For example, and with refence to Layout 1 of FIG. 22, a user might select bars 4-8 of Verse A and bars 9-13of Verse B and combine these into a new section for inclusion in Layout 1, such as by removing an existing section, or by adding a new section at a location along the layout. Such a new section may also be included in an alternative layout as desired.

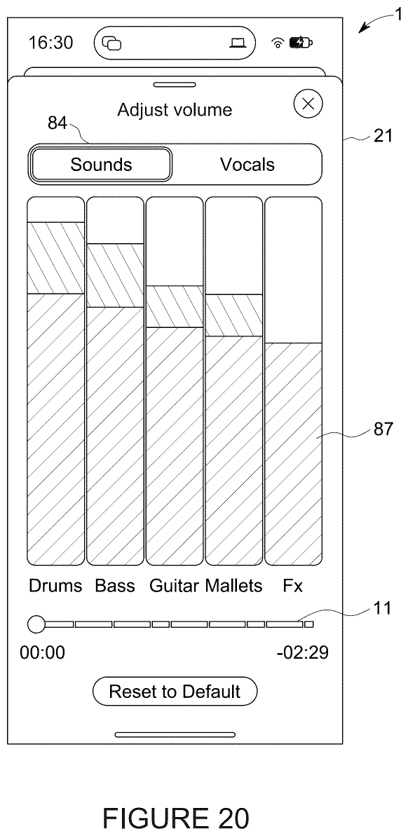

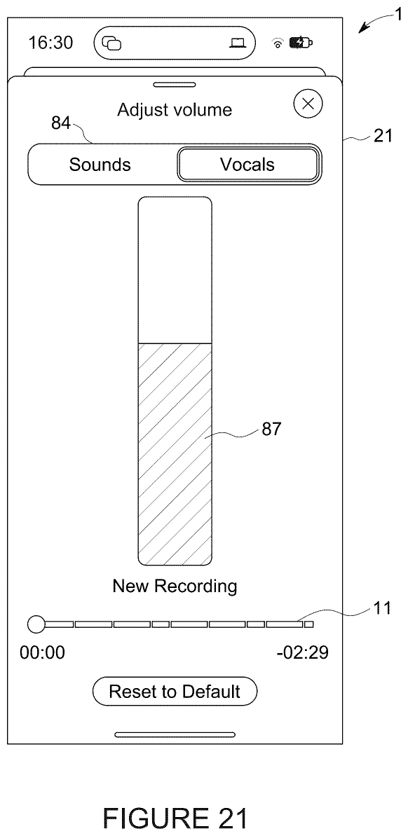

FIGS. 20 and 21 show an interactive authoring tool with means 84 enabling users to individually alter the volume of each instrument content block 4 and/or the volume of each vocal content block 5. The tool 84 may be provided as button or icon which may be swiped to toggle between volume adjustment for instrument content blocks 4 and vocal content blocks 5. A user may drag their finger or other pointing means to move the volume level up and down on the instrument or vocal bars 87 shown to increase or decrease volume levels as desired. As shown, the volume level for each instrument content block 4 and vocal content block 5 in a composition may be independently and individually adjusted.

The interactive authoring tools further include means enabling users to configure the audio output file for use in a short message capable of transmitted using a messaging service via a network to a device. Such a short message comprising the audio output file may have a duration or length of up to about thirty seconds, although optimally may have a duration of between three to twenty seconds, three to fifteen seconds, or three to nine seconds. A short message comprising the audio output file may further contain or be synchronized with one or more multimedia files, such as one or more image and/or video files, such that the audio output file is combined with the one or more multimedia files when the short message is played on the device.

Embodiments of the present invention further provide interactive authoring tools including means for storing a composed audio output file to library and to share an audio output file on alternative media platforms, such as social media platforms. Composed audio output files for a user may also be presented as a playlist and users may create such playlists. The user interface also provides means for searching audio output files composed and released by other users, as well as to search for other users.

The user interface also provides means for synchronising a video with an audio output file, including means for recording and editing such a video and means to add artwork including images and effects to images for an audio output file.

It is to be understood that embodiments of the invention are not limited to the specific details described herein which are given by way of example only and that various modifications and alterations are possible without departing from the scope of the invention.

What is claimed is:

1. A user interface apparatus for composing an audio output file, the user interface apparatus including:
an arrangement of a plurality interactively operable visual elements displayed on display means, each visual element represents an instrument content block, and each instrument content block comprises musical content from a musical instrument and has a plurality of audio parameters,
wherein an instrument content block is activated by a user tapping the corresponding visual element with pointing means, and
whereby, when an instrument content block is activated by a user one or more of a plurality of interactive authoring tools are provided to enable the user to adjust audio parameters of the activated instrument content block, and the audio parameters adjusted by the user are applied to the instrument content block,
means for composing the audio output file by combining the instrument content blocks.

2. The user interface apparatus of claim 1, in which the interactive authoring tools include means for instrument content block shuffle means configured so that when a visual element for an instrument content block is swiped with pointing means by a user the instrument content block is replaced with an alternative instrument content block.

3. The user interface apparatus of claim 2, in which the instrument content block shuffle means further comprises means for replacing the instrument content blocks with an alternative selection of instrument content blocks.

4. The user interface apparatus of claim 1, in which the interactive authoring tools provided to a user are dependent on the length of time a user taps a visual element, whereby a relatively short tap provides a first subset of the interactive authoring tools, and a relatively long tap provides a second subset of the interactive authoring tools.

5. The user interface apparatus of claim 1, in which the interactive authoring tools include means for displaying the instrument content blocks of the audio output file in a plurality of sections, in which each section displayed is populated by instrument content sub-blocks for each instrument content block, and whereby the user interface comprises means enabling users to disable and enable one or more musical content sub-blocks for an instrument content block in a section of the audio output file, and in which the interactive authoring tools include means for enabling users to reorder the sections of the audio output file.

6. The user interface apparatus of claim 1, in which the interactive authoring tools include means for enabling a user to add an instrument content block for a selected instrument and genre to the instrument content blocks in the audio output file.

7. The user interface apparatus of claim 1, in which each visual element includes a visual indication of a musical instrument corresponding to the musical content of the instrument content block, such visual indication is the name of the instrument written within or adjacent to the visual element and/or an image depicting the instrument shown within or adjacent to the visual element.

8. The user interface apparatus of claim 1, comprising one or more visual elements each representing a vocal content block, wherein a vocal content block is activated by a user tapping the corresponding visual element with pointing means, and when activated, one or more of a plurality of interactive authoring tools are provided to enable the user to adjust audio parameters of the activated vocal content block, and the user interface apparatus comprises means for combining the instrument content blocks and the one or more vocal content block to generate the audio output file.

9. The user interface apparatus of claim 1, comprising a visual element representing an empty vocal content block, wherein the empty vocal content block is activated by a user tapping the corresponding visual element with pointing means, and when activated provides means for enabling a user to record a vocal melody as a vocal recording and store the vocal recording as a vocal content block or part of a vocal content block.

10. The user interface apparatus of claim 9, in which the interactive authoring tools include means for recording, using input means such as a microphone, a vocal melody or other audio input as a vocal recording for selected predefined sections of the audio output file.

11. The user interface apparatus of claim 9, in which the interactive authoring tools include means for displaying lyrics for a vocal content block or part of a vocal content block.

12. The user interface apparatus of claim 9, in which the interactive authoring tools include means to autotune the vocal content block or part of a vocal content block.

13. The user interface apparatus of claim 9, comprising means for displaying the vocal recording as a visual element, wherein the vocal recordings are activated by a user tapping the corresponding visual element with pointing means, whereby when activated a plurality of interactive authoring tools are provided for enabling the user to adjust audio parameters of the vocal recording.

14. The user interface apparatus of claim 9, in which the interactive authoring tools further provides means for muting, locking, deleting, changing a musical style of, applying filters to, adjusting volume of, adjusting autotune level of, trimming, duplicating, naming and renaming, playing and/or restoring a vocal recording.

15. The user interface apparatus of claim 1, in which each visual element is an image of a ring.

16. A method of composing an audio output file using a user interface apparatus, the method including:
providing an arrangement of a plurality of interactively operable visual elements displayed on display means, each visual element represents an instrument content block, and each instrument content block comprises musical content from a musical instrument and has a plurality of audio parameters,
wherein an instrument content block is activated by a user tapping the corresponding visual element with pointing means, and
whereby, when an instrument content block is activated by a user one or more of a plurality of interactive authoring tools are provided to enable the user to adjust audio parameters of the activated instrument content block, and the audio parameters adjusted by the user are applied to the instrument content block,
combining the instrument content blocks to compose the audio output file.

17. The method of claim 16, comprising a steps of providing a visual element representing a vocal content block, wherein the vocal content block is activated by a user tapping the corresponding visual element with pointing means, and when activated, one or more of a plurality of interactive authoring tools are provided to enable the user to adjust audio parameters of the activated vocal content block, and combining the instrument content blocks and vocal content block to generate the audio output file.

18. The method of claim 16, comprising a step of providing a visual element representing an empty vocal content block, wherein the empty vocal content block is activated by a user tapping the corresponding visual element with pointing means, and when activated provides means for enabling a user to record a vocal melody as a vocal recording and store the vocal recording as a vocal content block or part of a vocal content block.

19. The method of claim 18, comprising a step of displaying a vocal recording as a visual element, wherein the vocal recording is activated by a user tapping the corresponding visual element with pointing means, whereby when activated a plurality of interactive authoring tools are provided for enabling the user to adjust audio parameters of the vocal recording.

20. A computer program that, when executed by one or more processors, cause the one or processors to perform the steps according to the method of claim 1.
